(19) United States
(12) Patent Application Publication
(10) Pub. No.: US 2018/0215247 A1
(43) Pub. Date: Aug. 2, 2018

(54) APPARATUS FOR A CLUTCH DISCONNECT IN A HYBRID VEHICLE

(71) Applicant: FORD GLOBAL TECHNOLOGIES, LLC, Dearborn, MI (US)

(72) Inventors: Anthony Mario D'AMATO, Canton, MI (US); Karin LOVETT, Novi, MI (US)

(21) Appl. No.: 15/417,255

(22) Filed: Jan. 27, 2017

(51) Int. Cl. B60K 6/387; B60K 6/48; B60K 6/365; B60K 23/04

(52) U.S. Cl. CPC B60K 6/387; B60K 6/48; B60Y 2400/421; B60K 23/04; B60K 6/365

(57) ABSTRACT

A vehicle comprising an electric motor configured to drive power to rear wheels of the vehicle. The vehicle also includes a mechanical disconnect configured to engage, when closed, a plurality of half shafts corresponding to the rear wheels and a drive shaft coupled to a differential, and to engage, when open, the drive shaft but not the plurality of half shafts.

### TECHNICAL FIELD

The present disclosure relates to a vehicle that may utilize a vehicle battery and motor, in conjunction with an engine, to drive power to the wheels.

### BACKGROUND

A hybrid vehicle is known to have an internal combustion engine and a battery working in conjunction with a motor, which can provide kinetic energy to the driveline of the hybrid vehicle. Torque and power flow may be sent to the rear wheels by both the motor and/or the engine via a drive shaft and half shafts for the respective rear wheels. Torque and power flow may also be sent from the rear wheels to both the motor and/or the engine via half shafts and the driveshaft.

### SUMMARY

A first illustrative embodiment discloses a vehicle comprising an electric motor configured to drive power to rear wheels of the vehicle. The vehicle also includes a mechanical disconnect configured to engage, when closed, a plurality of half shafts corresponding to the rear wheels and a drive shaft coupled to a differential, and to engage, when open, the drive shaft but not the plurality of half shafts.

A second illustrative embodiment discloses an electric vehicle comprising a differential including a first input configured to receive power from an engine via a driveshaft and a second input configured to receive power from a motor. The electric vehicle also includes a clutch in driveable communication with the differential and configured to, in an open position, permit power flow from the motor to the driveshaft and preclude power flow from the motor to rear wheels, and to, in a closed position, permit power flow from the motor to the driveshaft and rear wheels.

A third illustrative embodiment discloses a vehicle comprising a rear differential including a first input adjacent a transmission that is in drivable communication with an engine via a driveshaft that is connected to a second input of the rear differential. The vehicle also includes an electric motor in drivable communication with the rear differential via the transmission, and configured to drive power to first and second rear wheels of the vehicle via first and a second half shafts respectively. The vehicle further includes one or more mechanical disconnects located at the first and second half shafts configured to drive the first and second rear wheels respectively when closed, and to engage a drive shaft connected to the engine, but not the first and second half shafts, when open.

### BRIEF DESCRIPTION OF THE DRAWINGS

FIG. 1 illustrates a schematic diagram of a hybrid electric vehicle (HEV) and representative relationships among the components.

FIG. 2 illustrates an alternative embodiment of a HEV that includes a mechanical disconnect on respective half shafts.

FIG. 3a illustrates a torque/power flow diagram when a HEV has the engine and e-motor drive wheels when the vehicle speed is greater than zero and the clutch is closed.

FIG. 3b illustrates a torque/power flow diagram when a HEV has the engine charging the vehicle battery and drives the wheels when the vehicle speed is greater than zero and the clutch is closed.

FIG. 3c illustrates a torque/power flow diagram when a HEV has the wheels drive the electrical motor (regenerative braking) and the vehicle speed is greater than zero and the clutch is closed.

FIG. 4a illustrates a torque/power flow diagram when a HEV is in operation and the engine drives the electrical motor when the vehicle speed is greater than or equal to zero and the clutch is open.

FIG. 4b illustrates a torque/power flow diagram when a HEV is in operation and the electrical motor drives the engine the vehicle speed is greater than or equal to zero and the clutch is open.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Some hybrid architectures (e.g. P3) include a motor that is found after the transmission, driving the rear wheels by summing an electric-motor-torque with an internal combustion engine (ICE) torque before the differential. In such architecture, the traction motor may not be able to be utilized to charge a hybrid vehicle battery while the vehicle is stationary, without disconnecting the drive train from the wheels. Considering the substantial amount of torque on this path and the required hardware and controls complexity, a mechanical disconnect may be avoided.

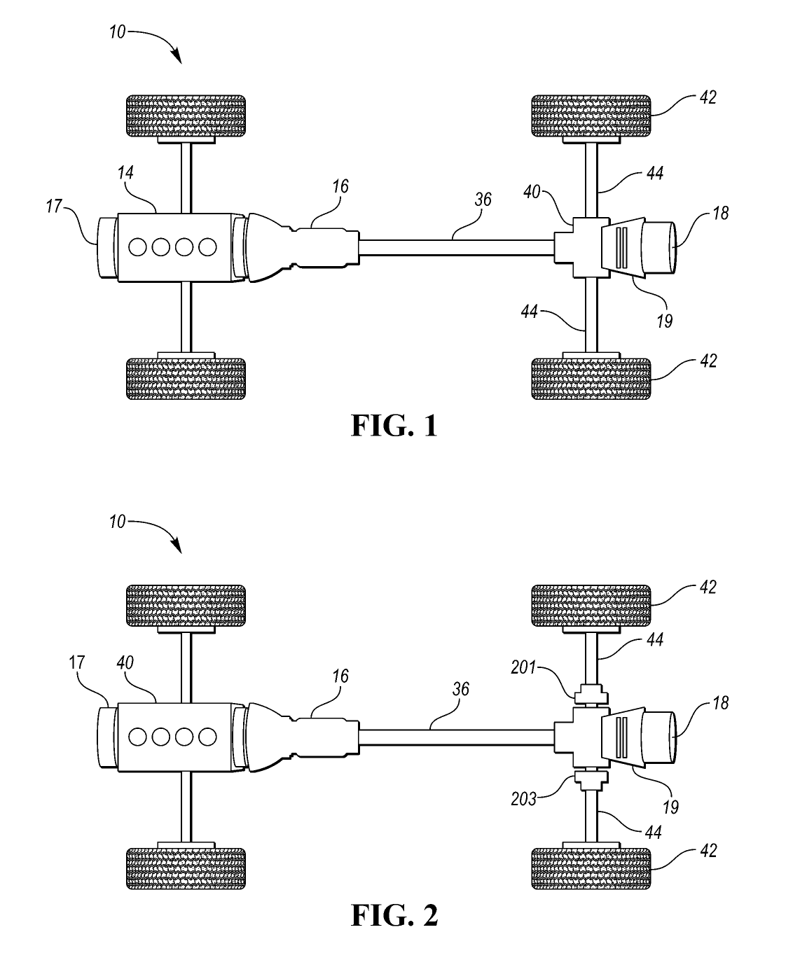

Referring to FIG. 1, a schematic diagram of a hybrid electric vehicle (HEV) 10 is illustrated according to an embodiment of the present disclosure. FIG. 1 illustrates representative relationships among the components. Physical placement and orientation of the components within the vehicle may vary. The HEV 10 includes a powertrain. The powertrain includes an engine 14 that drives a transmission 16. As will be described in further detail below, transmission 16 might include an electric machine such as an electric motor/generator (M/G), an associated traction battery, a torque converter, and a multiple step-ratio automatic transmission, or gearbox.

The engine 14 and the M/G 18 are both drive sources for the HEV 10. The engine 14 generally represents a power source that may include an internal combustion engine such as a gasoline, diesel, or natural gas powered engine, or a fuel cell. The engine 14 generates an engine power and corresponding engine torque that is supplied to the M/G 18 when a disconnect clutch between the engine 14 and the M/G 18 is at least partially engaged. The M/G 18 may be implemented by any one of a plurality of types of electric machines. For example, M/G 18 may be a permanent magnet synchronous motor. Power electronics condition direct current (DC) power provided by a battery to the requirements of the M/G 18, as will be described below. For example, power electronics may provide three phase alternating current (AC) to the M/G 18.

When a disconnect clutch is at least partially engaged, power flow from the engine 14 to the M/G 18 or from the M/G 18 to the engine 14 is possible. For example, the disconnect clutch may be engaged and M/G 18 may operate as a generator to convert rotational energy provided by a crankshaft and M/G shaft into electrical energy to be stored in the battery associated with the motor. The disconnect clutch can also be disengaged to isolate the engine from the remainder of the powertrain such that the M/G 18 can act as the sole drive source for the HEV 10. A Shaft extends through the M/G 18. The engine 14 is continuously drivably connected to the shaft (e.g. driveshaft 36), whereas the M/G 18 is drivably connected to the shaft 36 only when a disconnect clutch is at least partially engaged.

The M/G 18 is connected to a torque converter (e.g. in a motor/generator-transmission 19) via a shaft. The M/G 18 may include its own transmission system 19 distinct from The torque converter is therefore connected to the engine 14 when the disconnect clutch is at least partially engaged. The torque converter may include an impeller fixed to shaft 36 and a turbine fixed to a transmission input shaft. The torque converter thus provides a hydraulic coupling between shaft 30 and a transmission input shaft. The torque converter transmits power from the impeller to the turbine when the impeller rotates faster than the turbine. The magnitude of the turbine torque and impeller torque generally depend upon the relative speeds. When the ratio of impeller speed to turbine speed is sufficiently high, the turbine torque is a multiple of the impeller torque. A torque converter bypass clutch (also known as a torque converter lock-up clutch) may also be provided that, when engaged, frictionally or mechanically couples the impeller and the turbine of the torque converter, permitting more efficient power transfer. The torque converter bypass clutch may be operated as a launch clutch to provide smooth vehicle launch. Alternatively, or in combination, a launch clutch similar to disconnect clutch may be provided between the M/G 18 and gearbox for applications that do not include a torque converter or a torque converter bypass clutch. In some applications, disconnect clutch is generally referred to as an upstream clutch and launch clutch (which may be a torque converter bypass clutch) is generally referred to as a downstream clutch.

As shown in the representative embodiment of FIG. 1, the output shaft 36 is connected to a differential 40. The differential 40 drives a pair of wheels 42 via respective axles 44 or halfshafts 44 connected to the differential 40. The differential transmits approximately equal torque to each wheel 42 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain may include an associated controller, such as a powertrain control unit (PCU). While illustrated as one controller, the controller may be part of a larger control system and may be controlled by various other controllers throughout the vehicle 10, such as a vehicle system controller (VSC). It should therefore be understood that the powertrain control unit and one or more other controllers can collectively be referred to as a “controller” that controls various actuators in response to signals from various sensors to control functions such as starting/stopping engine 14, operating M/G 18 to provide wheel torque or charge battery, select or schedule transmission shifts, etc. Controller may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller communicates with various engine/vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, a controller may communicate signals to and/or from engine 14, a disconnect clutch (e.g. within the differential 40), M/G 18, battery, launch clutch, transmission gearbox, and power electronics. Although not explicitly illustrated, those of ordinary skill in the art will recognize various functions or components that may be controlled by controller within each of the subsystems identified above. Representative examples of parameters, systems, and/or components that may be directly or indirectly actuated using control logic and/or algorithms executed by the controller include fuel injection timing, rate, and duration, throttle valve position, spark plug ignition timing (for spark-ignition engines), intake/exhaust valve timing and duration, front-end accessory drive (FEAD) components such as an alternator, air conditioning compressor, battery charging or discharging (including determining the maximum charge and discharge power limits), regenerative braking, M/G operation, clutch pressures for disconnect clutch, launch clutch, and transmission gearbox, and the like. Sensors communicating input through the I/O interface may be used to indicate turbocharger boost pressure, crankshaft position (PIP), engine rotational speed (RPM), wheel speeds (WS1, WS2), vehicle speed (VSS), coolant temperature (ECT), intake manifold pressure (MAP), accelerator pedal position (PPS), ignition switch position (IGN), throttle valve position (TP), air temperature (TMP), exhaust gas oxygen (EGO) or other exhaust gas component concentration or presence, intake air flow (MAF), transmission gear, ratio, or mode, transmission oil temperature (TOT), transmission turbine speed (TS), torque converter bypass clutch status (TCC), deceleration or shift mode (MDE), battery temperature, voltage, current, or state of charge (SOC) for example.

Control logic or functions performed by controller may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

To drive the vehicle with the engine 14, a disconnect clutch is at least partially engaged to transfer at least a portion of the engine torque through the disconnect clutch to the M/G 18, and then from the M/G 18 through the torque converter and gearbox. The M/G 18 may assist the engine 14 by providing additional power to turn the shaft 30. This operation mode may be referred to as a “hybrid mode” or an “electric assist mode.”

To drive the vehicle with the M/G 18 as the sole power source, the power flow remains the same except the disconnect clutch isolates the engine 14 from the remainder of the powertrain. Combustion in the engine 14 may be disabled or otherwise OFF during this time to conserve fuel. A traction battery may transmit stored electrical energy through wiring to power electronics that may include an inverter, for example. The power electronics may convert DC voltage from the battery 20 into AC voltage to be used by the M/G 18. A controller may command the power electronics to convert voltage from the battery 20 to an AC voltage provided to the M/G 18 to provide positive or negative torque to the shaft 30. This operation mode may be referred to as an “electric only” or “EV” operation mode.

In any mode of operation, the M/G 18 may act as a motor and provide a driving force for the powertrain. Alternatively, the M/G 18 may act as a generator and convert kinetic energy from the powertrain into electric energy to be stored in the battery. The M/G 18 may act as a generator while the engine 14 is providing propulsion power for the vehicle 10, for example. The M/G 18 may additionally act as a generator during times of regenerative braking in which torque and rotational (or motive) energy or power from spinning wheels 42 is transferred back through the gearbox, torque converter, (and/or torque converter bypass clutch) and is converted into electrical energy for storage in a battery.

It should be understood that the schematic illustrated in FIG. 1 is merely exemplary and is not intended to be limiting. Other configurations are contemplated that utilize selective engagement of both an engine and a motor to transmit through the transmission. For example, the M/G 18 may be offset from the transmission system 16, an additional motor 17 (e.g. integrated starter generator or ISG) may be provided to start the engine 14, and/or the M/G 18 may be provided between a torque converter and a gearbox. The motor 17, such as an integrated starter generator (ISG) may allow for the HEV engine 14 to instantly and quietly restarts after an idle stop, which may allow the engine to shut down to save fuel and emissions. The ISG 17 may produce electrical power when the vehicle is running, which is used to supply electric devices and/or to charge the battery. The ISG 17 may also be used to help decelerate the vehicle by generating electrical power, for example during regenerative braking. The electrical power generated may charge the battery and reduce fuel consumption. If a clutch disconnects the ISG 17 and the compressor from the engine during the idle stop, the ISG 17 can drive the air-conditioning compressor via a belt. Other configurations are contemplated without deviating from the scope of the present disclosure.

During regenerative braking, it may be advantageous for the control system of the HEV 10 to coordinate the operation of the powertrain and braking systems to maximize fuel economy while also accounting for vehicle drivability. This may be accomplished by adapting the control systems to consider a wheel torque schedule, which may include anti-jerk control, during a regenerative braking event. Failing to consider the wheel torque schedule during regenerative braking may lead to torque holes during braking because the brake control is not aware of the actual status of the powertrain. This may also results in the transmission unnecessarily capacitating the torque converter to handle more negative torques when the powertrain has not actually requested so, causing waste of energy.

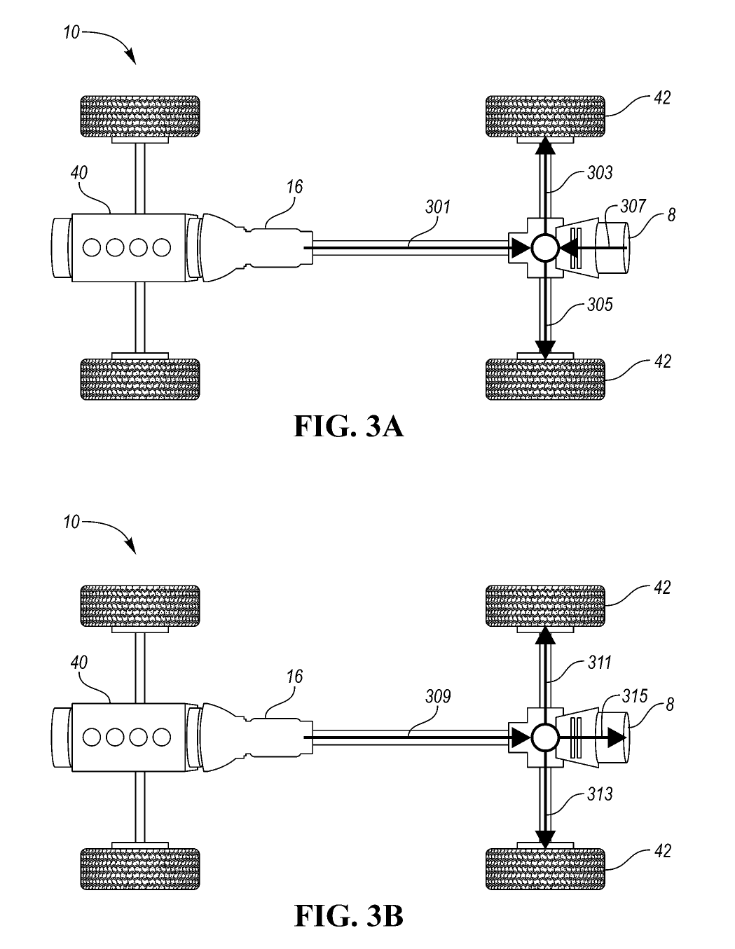

FIG. 2 illustrates an alternative embodiment of a HEV that includes a mechanical disconnect on respective half shafts. In such an embodiment, a first clutch or disconnect 201 and a second clutch or disconnect 203 may be located on respective half-shafts 44. Thus when the first clutch 201 and the second clutch 203 are in an open position, the electrical motor 18 will only drive torque and power via drive-shaft 30 to the engine 40.

The first clutch 201 and second clutch 203 may be a dog clutch, such as a single friction dog clutch, at the ring/half-shaft interface or a one-way clutch. A single clutch may be configured to selectively engage with a ring to the half-shafts 44. In yet another embodiment, the first clutch 201 and second clutch 203 may be an electronically controlled hydraulic rocker one-way clutch. Meshing gearing elements may have a fixed gear ratio configured to define an overdrive speed and torque relationship between the engine and the output shaft when the clutch is engaged. A controller may be configured to selectively command the clutch to engage or disengage in response to various operating conditions. Other gearing arrangements that impose an overdrive speed relationship between the engine and output shaft may, of course, be used. An alternative pinion location for the electrical motor 18 input to the differential 40 may also be located on a ring of the clutch.

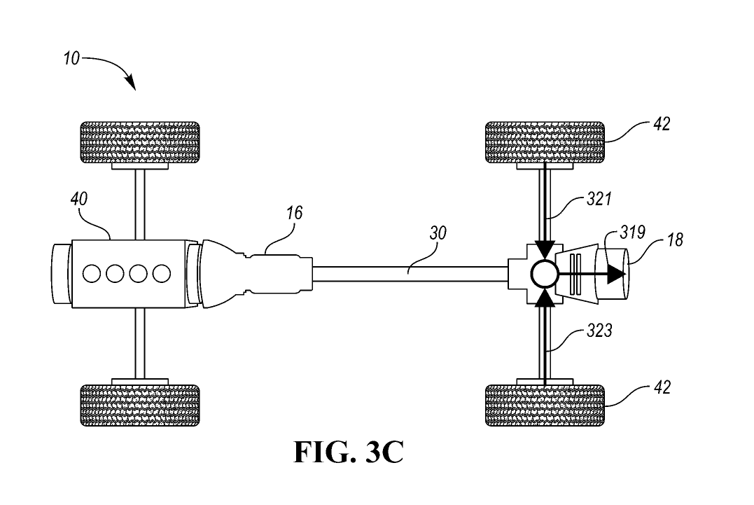

FIG. 3A illustrates a torque/power flow diagram when a HEV's wheels are driven by the engine and e-motor, and when the vehicle speed is greater than zero and the clutch is closed. Thus, the vehicle is moving and the vehicle may be in a full power mode where both the engine and electrical motor are providing tractive force. When both the motor 18 and the engine 40 are driving the wheels 42 and the clutch or disconnect is closed, the driveshaft torque/powerflow 301 flows from the engine 40 towards the differential. Drive-wheel powerflow 305 and passenger-wheel powerflow 303 are sent to the wheels 42. The motor 8 sends motor powerflow 307 to the wheels 42 through the closed clutch or differential.

FIG. 3B illustrates a torque/power flow diagram when a HEV has the engine charging the vehicle battery and drives the wheels when the vehicle speed is greater than zero and the clutch is closed. Thus, the vehicle is moving the vehicle may utilize excess engine power to charge the vehicle battery. The motor may be used to set the engine to an ideal fuel consumption (e.g. fuel economy mode). The engine 40 may produce a driveshaft torque/powerflow 309 through the transmission system 16. Driver-wheel powerflow 313 and passenger-wheel powerflow 311 are sent to the wheels 42. Furthermore, motor powerflow 315 is sent to the motor 8. In turn, the motor powerflow 315 is utilized to charge the battery.

FIG. 3C illustrates a torque/power flow diagram of an HEV that includes the wheels driving drive the electrical motor (e.g. regenerative braking) and the vehicle speed is greater than zero when the clutch is closed. When the wheels 42 are driving the motor 18, passenger-side wheel power flow 321 and driver-side wheel torque/power flow 323 will be transferred through the differential and disconnect. The passenger-side wheel torque/power flow 321 and driver-side wheel power flow 323 will be combined to transfer motor torque/power flow 319 to the electrical motor 18. Such a scenario may allow the battery to be charged and supplement friction brakes.

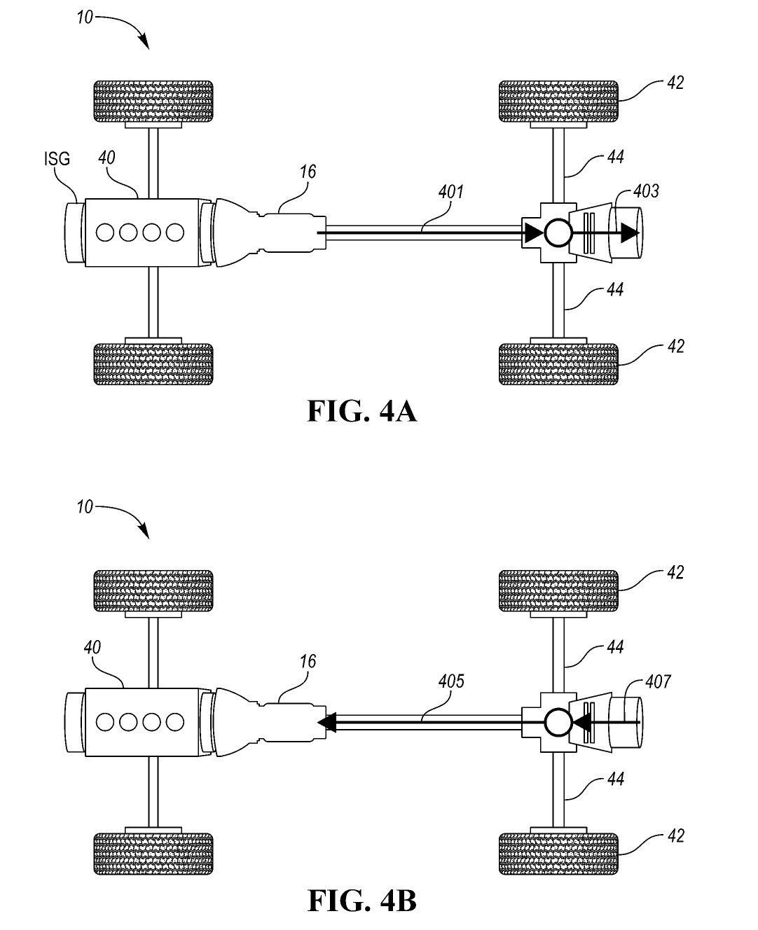

FIG. 4A illustrates a torque/power flow diagram of a HEV that is in operation that includes an engine that drives the electrical motor, and the HEV's vehicle speed is greater than or equal to zero with an open clutch. In FIG. 4A, the engine 40 is driving the electrical motor 18 and the vehicle is traveling at a speed greater to or equal than zero. The drive shaft transfers torque and power flow 401 from the engine 40 via the transmission system 401. When the clutch or mechanical disconnect is open, torque and power flow 403 is transferred to the motor 18. The wheels 42 and drive shaft 44 do not receive any of the torque and power flow 401 from the engine 40. Instead, the power flow is bypassed. Thus, the open clutch or mechanical disconnect may charge the hybrid vehicle battery while stationary. Without such a clutch or disconnect, the HEV may not be able to charge the hybrid battery when the vehicle is stationery, as torque and power flow would be required to transfer to the wheels 42.

FIG. 4B illustrates a torque/power flow diagram of a HEV that is in operation with a vehicle speed greater than or equal to zero with an open clutch, and the electrical motor is driving the engine. In FIG. 4B, the electrical motor 18 is driving the engine 40 and the vehicle is traveling at a speed greater to or equal than zero. When the clutch or mechanical disconnect is open and the motor 18 is driving the engine 40, torque and power flow 407 is transferred to the driveshaft. The wheels 42 and drive shaft 44 do not receive any of the torque and power flow 401 from the motor 18. Instead, the power flow is bypassed from the wheels to the driveshaft. The drive shaft transfers torque and power flow 405 to the engine 40 via the transmission system 401. Thus, the open clutch or mechanical disconnect may charge the hybrid vehicle battery while stationary. Without such a clutch or disconnect, the HEV may include some movement to the wheels during an engine start, causing the vehicle to lurch forward or backward during an engine start event.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
an electric motor configured to drive power to rear wheels of the vehicle; and
a mechanical disconnect configured to engage, when closed, a plurality of half shafts corresponding to the rear wheels and a drive shaft coupled to a differential, and to engage, when open, the drive shaft but not the plurality of half shafts.

2. The vehicle of claim 1, wherein the mechanical disconnect is configured to selectively allow electric air-conditioning operation while an internal combustion engine is running and the vehicle is stationary.

3. The vehicle of claim 2, wherein a closed-position of the mechanical disconnect permits power flow to the engine and the rear wheels.

4. The vehicle of claim 2, wherein an open-position of the mechanical disconnect is configured to decouple the motor from the rear wheels.

5. The vehicle of claim 1, wherein the mechanical disconnect is a dog clutch.

6. The vehicle of claim 1, wherein the mechanical disconnect is located on one of the half shafts corresponding to a driver-side rear tire.

7. An electric vehicle comprising:
a differential including a first input configured to receive power from an engine via a driveshaft and a second input configured to receive power from a motor; and
a clutch in driveable communication with the differential and configured to, in an open position, permit power flow from the motor to the driveshaft and preclude power flow from the motor to rear wheels, and to, in a closed position, permit power flow from the motor to the driveshaft and rear wheels.

8. The vehicle of claim 7, wherein the clutch is a dog clutch configured to engage, in the closed position, a plurality of half shafts corresponding to the rear wheels and the driveshaft.

9. The vehicle of claim 7, wherein the clutch is located on a half shaft connected to a driver-side rear tire.

10. The vehicle of claim 7, wherein the clutch is located on a half shaft connected to a passenger-side rear tire.

11. The vehicle of claim 7, wherein the clutch is further configured to permit, in the open position, an electric air-conditioning system of the vehicle to operate while the engine is running and the vehicle is stationary.

12. The vehicle of claim 7, wherein the clutch is further configured to permit, in the closed position, power flow to the engine and rear wheels.

13. The vehicle of claim 7, wherein the clutch is further configured to decouple, in the open position, the motor from the rear wheels.

14. The vehicle of claim 7, wherein the clutch is located within the differential.

15. A vehicle comprising:
a rear differential including a first input adjacent a transmission that is in drivable communication with an engine via a driveshaft that is connected to a second input of the rear differential;
an electric motor in drivable communication with the rear differential via the transmission, and configured to drive power to first and second rear wheels of the vehicle via first and a second half shafts respectively; and
one or more mechanical disconnects located at the first and second half shafts configured to drive the first and second rear wheels respectively when closed, and to engage a drive shaft connected to the engine, but not the first and second half shafts, when open.

16. The vehicle of claim 15, wherein the first half shaft is adjacent a third input of the rear differential and the second half shaft is adjacent a fourth input of the rear differential.

17. The vehicle of claim 15, wherein the one or more mechanical disconnects are further configured to permit power flow to the engine and the rear wheels when open.

18. The vehicle of claim 15, wherein the one or more mechanical disconnects are configured to selectively allow electric air-conditioning operation while the engine is running and the vehicle is stationary.

19. The vehicle of claim 15, wherein the one or more mechanical disconnects include a dog clutch.

20. The vehicle of claim 15, wherein the one or more mechanical disconnects are further configured to permit, when open, an electric air-conditioning system of the vehicle to operate while the engine is running and the vehicle is stationary.
